(19) United States
(12) Patent Application Publication
(10) Pub. No.: US 2006/0283343 A1
(43) Pub. Date: Dec. 21, 2006

(54) Perfecting press device

(76) Inventors: Fumiko Koyama, Ibaraki-ken (JP); Katsumi Ohno, Ibaraki-ken (JP)

Correspondence Address: Matthew K Ryan;Frommer Lawrence & Haug, 745 Fifthe Avenue, New York, NY, 10151, US

(21) Appl. No.: 10/552,323

(22) PCT Filed: Apr. 5, 2004
(86) PCT No.: PCT/JP04/04925

§ 371 Date: Oct. 7, 2005

(30) Foreign Application Priority Data
Apr. 8, 2003 (JP) 2003-104036

(51) Int. Cl. B41L 13/00

(52) U.S. Cl. 101/119

(57) ABSTRACT

A double-side printing system where printing is made on both sides of a printing paper has an image density calculator which calculates the image densities of image data of the front side and image data of the back side, and a printing density reducer which reduces both the printing densities for printing the image data of the front side and the image data of the back side when at least one of the image densities of the image data of the front side and the image data of the back side is not smaller than a predetermined value.

### FIELD OF THE INVENTION

This invention relates to a double-side printing system for making printing on both sides of a printing paper, and more particularly to such a double-side printing system which can prevent strike-through in the double-side printing.

### BACKGROUND OF THE INVENTION

Recently, the double-side printing where printing is made on both sides of a printing paper has been increasingly made in order to reduce the consumption of the printing papers. Also in the stencil printing where one-side printing has been prevailing, the double-side printing has been increasingly made and in order to shorten the printing time, there has been developed a double-side printing system which can print on both sides of a printing paper in one printing step. As an example of such a double-side printing system, there has been proposed in Japanese Unexamined Patent Publication No. 2001-180998 a system where first and second cylindrical printing drums each provided with a stencil wound around its outer peripheral surface are disposed adjacent to each other with their rotary axes in parallel to each other, a printing paper is supplied between the first and second printing drums, and the first and second printing drums pinch the printing paper to convey it, whereby ink is transferred to both sides of the printing paper through the stencils. In such a double-side printing system, generally the double-side printing and the one-side printing can be switched.

In printing, ink is sometimes transferred to a printing paper in an amount beyond the amount which the printing paper can hold and strike-through, where the ink penetrates to the back side of the printing paper, can sometimes occurs. When the image to be printed includes a solid part, the strike-through is especially apt to occur. In the case of the double-side printing, the strike-through is further apt to occur since the ink is transferred to both sides of the printing paper. When such strike-through occurs upon the double-side printing, the contents of the strike through printing overlap with the contents of the printing printed on the back side thereof to make it difficult to understand the contents of printing, whereby quality as the printings remarkably deteriorates.

In order to prevent occurrence of the strike-through upon the double-side printing, there has been proposed, for instance, in Japanese Unexamined Patent Publication No. 2000-190610, a double-side printing system where the printing density upon the double-side printing is reduced by making the diameter of the perforations of the stencils for the double-side printing smaller than those for the one-side printing.

Further, in order to prevent occurrence of the strike-through upon printing of an image including a solid part, there has been proposed, for instance, in Japanese Unexamined Patent Publication No. 5(1993)-22582, a printing system where the density of the image to be printed, that is, whether the image to be printed includes a solid part is detected prior to the printing, and when the image to be printed includes a solid part, the printing density is reduced.

### SUMMARY OF THE INVENTION

In accordance with the present invention, there is provided a double-side printing system where printing is made on both sides of a printing paper comprising an image density detecting means which detects the image densities of input image data of the front side and input image data of the back side, and a printing density reducing means which reduces both the printing densities for printing the input image data of the front side and the input image data of the back side when at least one of the image densities of the input image data of the front side and the input image data of the back side is not smaller than a predetermined value.

When the image data comprises pieces of black data (ON dots) and pieces of white data (OFF dots), the image density detecting means may detect as the image density the proportion of the number of pieces of black data to the total number of the pieces of image data in a predetermined area of the image represented by the image data.

The image density detecting means may be provided with a thinning means which thins the input image data of the front side and the input image data of the back side.

When the image density detecting means divides the image represented by the image data into a plurality of areas to detect the image densities for each of the areas, the printing density reducing means may reduce said printing densities when at least one of the image density detected in the areas is not smaller than a predetermined value.

When the image density detecting means detects, when pieces of image data of at least three pages are input as a set, the image densities of pieces of image data of all the pages input as a set, the printing density reducing means may reduce the printing density for printing the input image data of all the pages.

### BRIEF DESCRIPTION OF THE DRAWINGS

FIG. 1 is a view showing a stencil printer in accordance with an embodiment of the present invention,

FIG. 2 is a view showing in brief the control portion,

FIG. 3 is a flow chart showing the operation of the control portion.

### PREFERRED EMBODIMENTS OF THE INVENTION

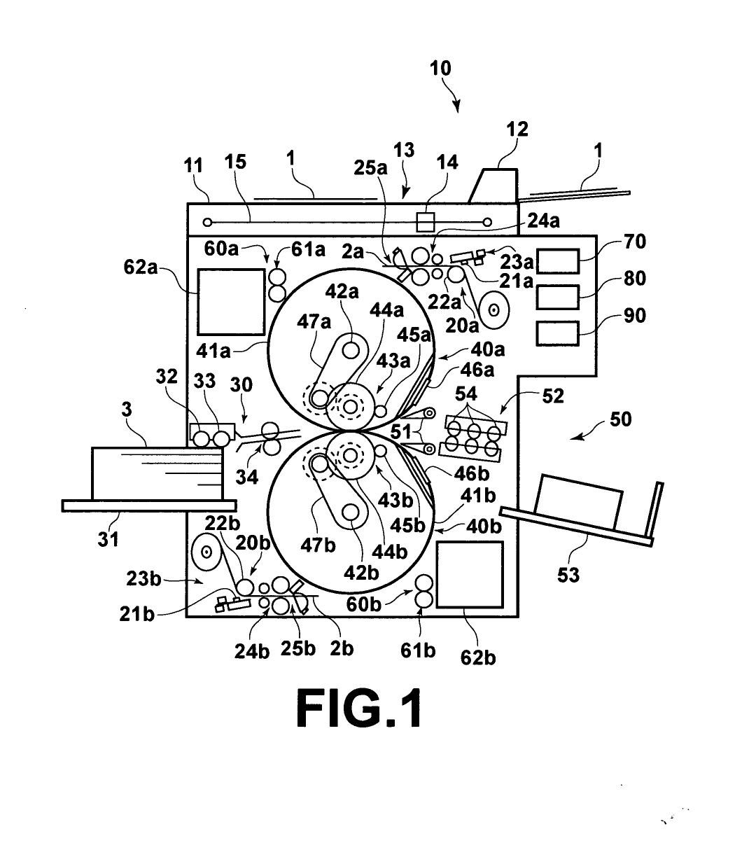

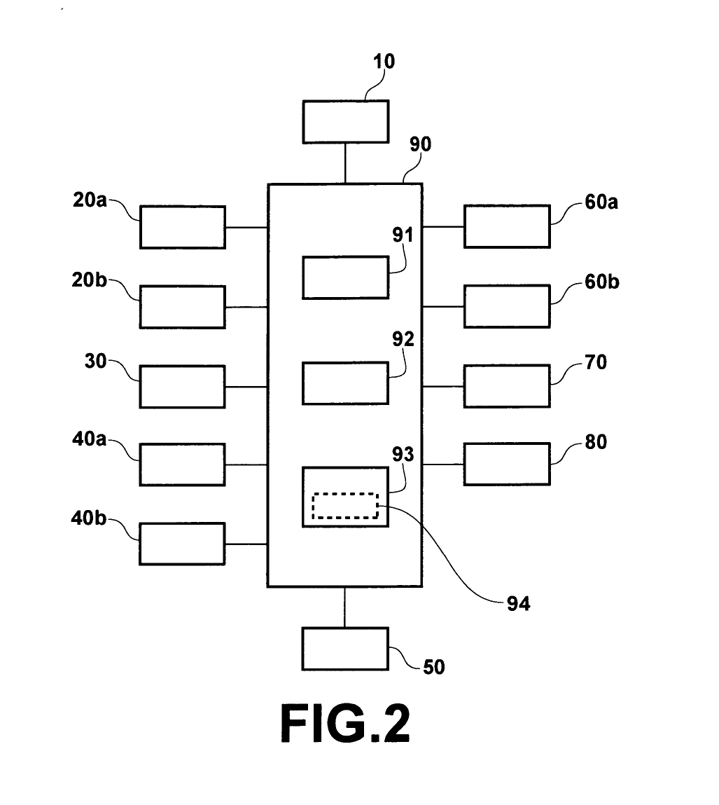

An embodiment of the present invention will be described in detail with reference to the drawings, hereinbelow. FIG. 1 is a view showing a stencil printer in accordance with an embodiment of the present invention, and FIG. 2 is a view showing in brief the control portion 90 of the stencil printer. As shown in FIG. 1, the stencil printer is a stencil printer in which both the double-side printing and the one-side printing are feasible and comprises a reading portion 10 which reads out an image on an original 1, a first stencil making portion 20a which makes a stencil 2a from stencil material on the basis of the image data read by the reading portion 10, a second stencil making portion 20b which makes a stencil 2b from stencil material on the basis of the image data read by the reading portion 10, a paper supply portion 30 which supplies the printing papers 3, a first printing drum 40a which prints on the printing paper 3 by the use of the stencil 2a, a second printing drum 40b which prints on the printing paper 3 by the use of the stencil 2b, a paper discharge portion 50 which discharges the printed printing papers 3, a first stencil discharge portion 60a which discharges the stencil 2a, a second stencil discharge portion 60b which discharges the stencil 2b, an inputting portion 70 for performing setting of the number of copies, selection of the double-side printing or the one-side printing, and the like, a display portion 80 which displays, for instance, conditions of setting and a control portion 90 which is connected to each part of the stencil printer to control the part.

The image read-out portion 10 comprises an original table 11 on which the original 1 is placed when an image thereon is read out, an original supply portion 12 which automatically supplies an original 1 to an original reading position on the original table 11, and a read-out portion 13. The read-out portion 13 comprises an image sensor 14 and a reciprocating portion 15 which moves back and forth the image sensor 14 and may be a belt-pulley mechanism. The image sensor 14 moves along the under side of the original 1 placed on the original table 11 in the original reading position and reads out the image on the original 1. The image sensor 14 outputs to the control portion 90 an electric signal carrying thereon information of the image on the original 1 (will be referred to as “read-out signal”, hereinbelow).

The first stencil making portion 20a comprises a stencil portion 23a storing therein a stencil material roll and comprising a thermal head 21a and a platen roller 22a, a stencil feed portion 24a which conveys the stencil material, and a stencil cutter 25a which cuts the stencil 2a from the stencil material. In the stencil portion 23a, the stencil material is perforated by the thermal head 21a and the platen roller 22a on the basis of stencil data to be described later, thereby making the stencil 2a. The stencil 2a is conveyed by the stencil feed portion 24a and cut by the stencil cutter 25a from the stencil material. Thereafter, the stencil 2a is sent to the first printing drum 40a. The second stencil making portion 20b is of substantially the same structure as the first stencil making portion 20a though different from the latter in position and orientation, and accordingly, will not be described in detail.

The paper supply portion 30 comprises a paper supply table 31 on which printing papers 3 are stacked, a paper supply roller 32 which takes out the printing papers 3 one by one from the paper supply table 31, a sheet separating roller 33 and a pair of timing rollers 34 which send a printing paper 3 between the first and second printing drums 40a and 40b.

The first printing drum 40a has an ink-transmitting peripheral wall 41a and is rotated about a shaft 42a by a drive means not shown. An ink supply means 43a is provided inside the first printing drum 40a. The ink supply means 43a comprises an ink supply roller 44a in contact with the inner peripheral surface of the peripheral wall 41a and a doctor roller 45a which supplies ink, supplied through an ink supply pipe (not shown), to the ink supply roller 44a in a predetermined amount. A clamp portion 46a which holds the leading end of the stencil 2a is provided on the outer peripheral surface of the peripheral wall 41a of the first printing drum 40a. The stencil 2a made by the first stencil making portion 20a is held by the clamp portion 46a at its leading end and wound around the outer peripheral surface of the peripheral wall 41a as the first printing drum 40a rotates.

A pressing mechanism 47a for moving up and down the ink supply roller 44a is provided inside the first printing drum 40a. As shown in FIG. 1, the second printing drum 40b is of substantially the same structure as the first printing drum 40a except that the second printing drum 40b is inverted, and accordingly, will not be described in detail.

The printing paper 3 is pinched by the first and second printing drums 40a and 40b when printing is to be effected. A slight space is provided between the first and second printing drums 40a and 40b so that they cannot be brought into direct contact with each other even when they are rotated with no printing paper fed therebetween.

When a printing paper is fed from the paper supply portion 30, the ink supply roller 44a is moved downward toward the outer peripheral surface of the first printing drum 40a to move downward the outer peripheral surface of the same from inside by the pressing mechanism 47a. By this, the outer peripheral surface of the first printing drum 40a is brought into abutment against the front side of the printing paper 3 and the outer peripheral surface of the second printing drum 40b is brought into abutment against the back side of the same. In response to rotation of the first and second printing drums 40a and 40b, the printing paper 3 is conveyed and the double-side printing is carried out on the sides of the printing paper 3.

The paper discharge portion 50 comprises separators 51 which peel the printing paper 3 off the first and second printing drums 40a and 40b, a paper discharge portion 52 which conveys the printed printing paper 3, and a paper discharge table 53 on which the printed printing papers 3 are stacked. The paper discharge portion 52 comprises a plurality of pairs of pinch rollers 54 which are driven at a constant speed by a drive motor (not shown) and the printing paper 3 is conveyed by being delivered from upstream side pinch rollers 54 to downstream side pinch rollers 54.

The first stencil discharge portion 60a comprises a stencil separator (not shown) which is provided near the first printing drum 40a to peel the stencil 2a off the first printing drum 40a after use, a pair of stencil discharge rollers 61a which convey the stencil 2a peeled off the first printing drum 40a, a stencil discharge box 62a in which the conveyed stencil 2a is placed. Since being of substantially the same structure as the first stencil discharge portion 60a though different from the latter in position and orientation, the second stencil discharge portion 60b will not be described in detail.

The control portion 90, as shown in FIG. 2, comprises an image data generating portion 91 which generates image data for making a stencil by carrying out image processing such as A/D conversion or binary-coding on the read-out signal output from the reading portion 10, an image memory 92 which stores the image data generated by the image data generating portion 91 and a stencil data generating portion 93 which generates stencil data on the basis of the image data stored in the image memory 92 and outputs the stencil data to the stencil portions 23aand 23b. The stencil data generating portion 93 comprises an image density detecting portion 94 which, when the double-side printing is selected, detects whether the density of the image data is not smaller than a predetermined value. As shown in FIG. 2, the control portion 90 is connected to the reading portion 10, the first and second stencil making portions 20aand 20b, the paper supply portion 30, the first and second printing drums 40a and 40b, the paper discharge portion 50, the first and second stencil discharge portions 60a and 60b, the inputting portion 70, the display portion 80 and controls each part during the stencil making or the printing. The stencil data generating portion 93 includes a function as the printing density reducing means in the present invention.

Operation of the stencil printer of this embodiment will be described, hereinbelow.

First, the user selects whether the one-side printing is to be made or the double-side printing is to be made on the inputting portion 70. The operation when the one-side printing is selected will be described first.

When the one-side printing is to be made, an original is set to the original supply portion 12. The original 1 is placed in the original reading position on the original table 11 from the original supply portion 12 under the control of the control portion 90 and the image on the original 1 is read out by the image sensor 14 and the read-out signal is output to the control portion 90. The image data generating portion 91 generates image data by carrying out A/D conversion or binary-coding on the read-out signal and stores the same in the image memory 92. The stencil data generating portion 93 generates stencil data on the basis of the image data stored in the image memory 92 and outputs the stencil data to the stencil portion 23a.

The stencil portion 23a controls heat generation of the thermal head 21a on the basis of the stencil data, whereby a stencil 2a is made. The stencil 2a is conveyed by the stencil feed portion 24a and cut in a predetermined size by the cutter 25a. Then the stencil 2a is wound around the first printing drum 40a. Thereafter a printing paper is supplied by the paper supply portion 30 and the one-side printing is made.

The operation when the double-side printing is selected will be described next.

When the double-side printing is to be made, a pair of originals are set to the original supply portion 12. A first original 1 (for the front side) is placed in the original reading position on the original table 11 from the original supply portion 12 under the control of the control portion 90 and the image on the first original 1 is read out by the image sensor 14 and the read-out signal is output to the control portion 90. Then a second original 1 (for the back side) is placed in the original reading position on the original table 11 from the original supply portion 12 under the control of the control portion 90 and the image on the second original 1 is read out by the image sensor 14 and the read-out signal is output to the control portion 90.

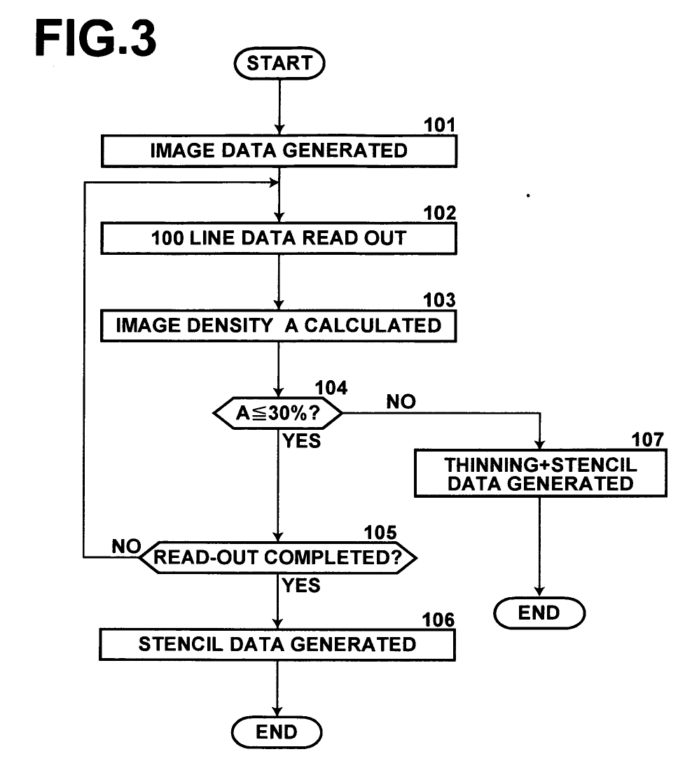

Detail of the operation of the control portion 90 will be described with reference to the flow chart shown in FIG. 3, hereinbelow. In step 101, the image data generating portion 91 digitizes the input read-out signal and carries out the normal image processing on the resultant read-out signal to generate image data and stores the image data in the image memory 92. That is, image data for the front side and image data for the back side are stored in the image memory 92.

Then in step 102, the stencil data generating portion 93 reads out image data for a predetermined area of the image represented by the image data stored in the image memory 92, for instance, an area corresponding to 100 lines thereof. Since having been binary-coded, the image data comprises pieces of black data (ON dots) and pieces of white data (OFF dots).

In step 103, the image density detecting portion 94 calculates the percentage of the number of pieces of black data to the number of pieces of the whole data with the image density of the image data of the area corresponding to 100 lines taken as A. In step 104, the stencil data generating portion 93 determines whether the image density A is not larger than 30%. When the image density A is not larger than 30%, the step proceeds to step 105 whereas when the proportion of the number of pieces of black data exceeds 30%, the step proceeds to step 107.

In step 105, it is determined whether all the image data stored in the image memory 92 (including the image data for the front side and the image data for the back side) has been read out. When all the image data stored in the image memory 92 has not been read out, the step returns to step 102 and the image data for next 100 lines is read out. When all the image data stored in the image memory 92 has been read out, the step proceeds to step 106.

In step 106, the normal stencil data is generated on the basis of the image data for the front side and the image data for the back side stored in the image memory 92. The stencil data for the front side thus generated is output to the stencil portion 23a and the stencil data for the back side thus generated is output to the stencil portion 23b. When substantially the whole of the image represented by the image data is formed by characters, usually, the image density A does not exceed 30% in any area of the image data. That is, in the case where the step proceeds to step 106, it may be considered that the image represented by the image data for the front side and the image represented by the image data for the back side are substantially wholly formed by characters. Accordingly, even if the double-side printing is performed by the use of the image data for the front side and the image data for the back side as they are, there is little probability that the strike-through occurs. Accordingly, it is not necessary to reduce the printing density.

In step 107, the stencil data generating portion 93 generates stencil data by carrying out thinning, which is a reduction of the printing density, on the image data for the front side and the image data for the back side. The thinned stencil data for the front side is output to the stencil portion 23a and the thinned stencil data for the back side is output to the stencil portion 23b. As the thinning, for example, the image data may be coercively converted to white data every two pixels in the main scanning direction and the sub-scanning direction. By this processing, when the pixel originally has white data, the stencil data is held to be white data and the solid part where, for instance, a plurality of pieces of black data are continuous, the stencil data has pieces of black data and white data arranged in a zigzag pattern.

In the case where the step proceeds to step 107, it may be considered that the image represented by the image data for the front side and the image represented by the image data for the back side include at least one area where the image density A exceeds 30%, that is, an area not formed by characters. Accordingly, when the double-side printing is performed by the use of the image data for the front side and the image data for the back side as they are, there is a probability that the strike-through occurs. Whereas, when the stencil data is made with the thinning described above, the printing density is reduced and there is no probability that the strike-through occurs.

When stencil data is output by the processing described above, heat generation of the thermal head 21a on the basis of the stencil data for the front side to make a stencil 2a in the stencil portion 23a. The stencil 2a is conveyed by the stencil feed portion 24a and cut in a predetermined size by the cutter 25a. Then the stencil 2a is wound around the first printing drum 40a. Similarly, heat generation of the thermal head 21a on the basis of the stencil data for the back side to make a stencil 2b in the stencil portion 23b. The stencil 2b is conveyed by the stencil feed portion 24a and cut in a predetermined size by the cutter 25a. Then the stencil 2a is wound around the second printing drum 40b. Thereafter a printing paper is supplied by the paper supply portion 30 and the double-side printing is made up to the preset number of copies.

As can be understood from the description above, since when an image density higher than a predetermined value is detected in at least one of the image data for the front side and the image data for the back side by the image density detecting portion 94, the printing density is reduced when the image data for the front side and the image data for the back side are printed, occurrence of the strike-through is prevented and the double-side printing which cannot embarrass the user can be performed. Further, by reducing the printing density, offset where ink is transferred to the upper or lower printing paper when a printed printing paper is stacked on the paper discharge table can be simultaneously prevented.

Further, since the proportion of the number of pieces of black data to the number of pieces of the whole data in a predetermined area represented by the image data is detected as the image density, the image density can be easily detected.

Further, since the printing density is reduced by making the stencil data by thinning the image data for the front side and the image data for the back side, the printing density can be easily reduced.

Further, since the image represented by the image data is divided into areas each corresponding to 100 lines and the image density is detected by the areas, and the printing density is reduced when the image density detected at least one 100 line area is not smaller than a predetermined value, the printing density is reduced when the image to be printed includes a solid part or the like, and the strike-through can be surely prevented.

Though, in this embodiment, the printing density is reduced by thinning, the printing density may be reduced in any other methods. For example, the printing density may be reduced by reducing the diameter of the perforations by controlling the heat generating energy of the thermal head 21a. Further, dotting may be done in addition to thinning.

Though, in this embodiment, a stencil printer is employed as the printing system, the printing system may be any without being limited to the stencil printer. For example, an inkjet type printing system may be employed. In this case, the printing density may be reduced by thinning as in the embodiment described above, or may be reduced by reducing the amount of discharged ink.

Though, in this embodiment, a case where image data is printed on two pages of a printing paper, i.e. the front side and the back side of a printing paper has been described by way of example for the purpose of simplicity, the printing system may print image data of a lot of pages not smaller than three pages. In this case, the image density may be detected every two pages for the front side and the back side so that when an image density higher than a predetermined value is detected in at least one of the image data for the front side and the image data for the back side, the printing density for the image data of the two pages is reduced, or the image density for all the pages may be detected prior to the printing so that when an image density higher than a predetermined value is detected in the image data for at least one of the pages, the printing density for the image data of all the pages is reduced. In the case where the printing density for the image data of all the pages is reduced, occurrence of the strike-through is prevented and the double-side printing in which the printing densities for all the pages are untied and the user is not embarrassed can be performed.

1-4. (canceled)

5. A double-side printing system where printing is made on both sides of a printing paper comprising
an image density detecting means which detects the image densities of input image data of the front side and input image data of the back side, and
a printing density reducing means which reduces both the printing densities for printing the input image data of the front side and the input image data of the back side when at least one of the image densities of the input image data of the front side and the input image data of the back side is not smaller than a predetermined value.

6. A double-side printing system as defined in claim 5 in which the image data comprises pieces of black data and pieces of white data, and the image density detecting means detects as the image density the proportion of the number of pieces of black data to the total number of the pieces of image data in a predetermined area of the image represented by the image data.

7. A double-side printing system as defined in claim 6 in which the image density detecting means divides the image represented by the image data into a plurality of areas to detect the image densities for each of the areas, and the printing density reducing means reduces said printing densities when at least one of the image density detected in the areas is not smaller than a predetermined value.

8. A double-side printing system as defined in claim 6 in which the image density detecting means detects, when pieces of image data of at least three pages are input as a set, the image densities of pieces of image data of all the pages input as a set, and the printing density reducing means reduces the printing density for printing the input image data of all the pages.

9. A double-side printing system as defined in claim 7 in which the image density detecting means detects, when pieces of image data of at least three pages are input as a set, the image densities of pieces of image data of all the pages input as a set, and the printing density reducing means reduces the printing density for printing the input image data of all the pages.

10. A double-side printing system as defined in claim 5 in which the image density detecting means divides the image represented by the image data into a plurality of areas to detect the image densities for each of the areas, and the printing density reducing means reduces said printing densities when at least one of the image density detected in the areas is not smaller than a predetermined value.

11. A double-side printing system as defined in claim 10 in which the image density detecting means detects, when pieces of image data of at least three pages are input as a set, the image densities of pieces of image data of all the pages input as a set, and the printing density reducing means reduces the printing density for printing the input image data of all the pages.
